(19) United States
(12) Patent Application Publication
(10) Pub. No.: US 2015/0357053 A1
(43) Pub. Date: Dec. 10, 2015

(54) CRUSH RESISTANT NUCLEAR FUEL ASSEMBLY SUPPORT GRID

(71) Applicant: Westinghouse Electric Company LLC, Cranberry Township, PA (US)

(72) Inventors: Leo A. Carrilho, Lexington, SC (US); Joonhyung Choi, Lexington, SC (US)

(73) Assignee: WESTINGHOUSE ELECTRIC COMPANY LLC, Cranberry Township, PA (US)

(21) Appl. No.: 14/300,259

(22) Filed: Jun. 10, 2014

(51) Int. Cl. G21C 3/356

(52) U.S. Cl. CPC G21C 3/356

(57) ABSTRACT

A spacer grid design for a nuclear fuel assemblies that exhibits increased crush strength. The walls of the grid straps that surround the fuel elements have a number of dimples and/or springs with the flat surfaces of those walls formed with a plurality of emboss geometries that are formed in a symmetrical pattern with the pattern covering substantially an entire area of the wall except for the contact surfaces of the dimples and springs that interface with the fuel rods.

### BACKGROUND

1. Field

This invention pertains generally to a nuclear reactor fuel assembly and, more particularly, to a nuclear fuel assembly that employs a robust spacer grid.

2. Description of Related Art

The primary side of nuclear reactor power generating systems which are cooled with water under pressure comprises a closed circuit which is isolated and in heat exchange relationship with a secondary circuit for the production of useful energy. The primary side comprises the reactor vessel enclosing a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump and a system of pipes which are connected to the vessel form a loop of the primary side.

For the purpose of illustration, FIG. 1 shows a simplified nuclear reactor primary system, including a generally cylindrical reactor pressure vessel 10 having a closure head 12 enclosing a nuclear core 14. A liquid reactor coolant, such as water, is pumped into the vessel 10 by pump 16, through the core 14 where heat energy is absorbed and is discharged to a heat exchanger 18, typically referred to as a steam generator, in which heat is transferred to a utilization circuit (not shown), such as a steam driven turbine generator. The reactor coolant is then returned to the pump 16, completing the primary loop. Typically, a plurality of the above-described loops are connected to a single reactor vessel 10 by reactor coolant piping 20.

An exemplary reactor design is shown in more detail in FIG. 2. In addition to the core 14 comprised of a plurality of parallel, vertical, co-extending fuel assemblies 22, for purpose of this description, the other vessel internal structures can be divided into the lower internals 24 and the upper internals 26. In conventional designs, the lower internals' function is to support, align and guide core components and instrumentation as well as direct flow within the vessel. The upper internals restrain or provide a secondary restraint for the fuel assemblies 22 (only two of which are shown for simplicity in FIG. 2), and support and guide instrumentation and components, such as control rods 28. In the exemplary reactor shown in FIG. 2, coolant enters the reactor vessel 10 through one or more inlet nozzles 30, flows down through an annulus between the vessel and the core barrel 32, is turned 180° in a lower plenum 34, passes upwardly through a lower support plate 37 and a lower core plate 36 upon which the fuel assemblies are seated and through and about the assemblies. In some designs, the lower support plate 37 and the lower core plate 36 are replaced by a single structure, a lower core support plate having the same elevation as 37. The coolant flow through the core and surrounding area 38 is typically large on the order of 400,000 gallons per minute at a velocity of approximately 20 feet per second. The resulting pressure drop and frictional threes tend to cause the fuel assemblies to rise, which movement is restrained by the upper internals, including a circular upper core plate 40. Coolant exiting the core 14 flows along the underside of the upper core plate 40 and upwardly through a plurality of perforations 42. The coolant then flows upwardly and radially outward to one or more outlet nozzles 44.

The upper internals 26 can be supported from the vessel or the vessel head and include an upper support assembly 46. Loads are transmitted between the upper support assembly 46 and the upper core plate 40, primarily by a plurality of support columns 48. Support columns are respectively aligned above selected fuel assemblies 22 and perforations 42 in the upper core plate 40.

Rectilinearly moveable control rods 28, which typically include a drive shaft 50 and a spider assembly 52 of neutron poison rods, are guided through the upper internals 26 and into aligned fuel assemblies 22 by control rod guide tubes 54. The guide tubes are fixedly joined through the upper support assembly 46 and the top of the upper core plate 40. The support column 48 arrangement assists in retarding guide tithe deformation under accident conditions which could detrimentally affect control rod insertion capability.

FIG. 3 is an elevation view, represented in vertically shortened form, of a fuel assembly being generally designed by reference character 22. The fuel assembly 22 is the type used in a pressurized water reactor and has a structural skeleton, which at its lower end includes a bottom nozzle 58. The bottom nozzle 58 supports the fuel assembly 22 on the lower core plate 36 in the core region of the nuclear reactor. In addition to the bottom nozzle 58, the structural skeleton of the fuel assembly 22 also includes atop nozzle 62 at its upper end and a number of guide tubes or thimbles 84 which align with the guide tubes 54 in the upper internals. The guide tubes or thimbles 84 extend longitudinally between the bottom and top nozzles 58 and 62 and at opposite ends are rigidly attached thereto.

The fuel assembly 22 further includes a plurality of transverse grids 64 axially spaced along and mounted to the guide thimbles 84 and an organized array of elongated fuel rods 66 transversely spaced and supported by the grids 64. A plan view of a grid 64 without the guide thimbles 84 and fuel rods 66 is shown in FIG. 4. The guide thimbles 84 pass through the cells labeled 96 and the fuel rods occupy the cells 94. As can be seen from FIG. 4, the grids 64 are conventionally formed from an array of orthogonal straps 86 and 88 that are interleaved in an egg-crate pattern with the adjacent interface of four straps defining approximately square support cells through which the fuel rods 66 are supported in the cells 94 in transverse, spaced relationship with each other. In many designs, springs 90 and dimples 92 are stamped into the opposite walls of the straps that form the support cells 94. The springs and dimples extend radially into the support cells and capture fuel rods 66 therebetween; exerting pressure on the fuel rod cladding to hold the rods in position. The orthogonal array of straps 86 and 88 is welded at each strap end to a bordering strap 98 to complete the grid structure 64. Also, the assembly 22, as shown in FIG. 3, has an instrumentation tube 68 located in the center thereof that extends between and is captured by the bottom and top nozzles 58 and 62. With such an arrangement of parts, fuel assembly 22 forms an integral unit capable of being conveniently handled without damaging the assembly of parts.

As mentioned above, the fuel rods 66 in the array thereof in the assembly 22 are held in spaced relationship with one another by the grids 64 spaced along the fuel assembly length. Each fuel rod 66 includes a plurality of nuclear fuel pellets 70 and is closed at its opposite ends by upper and lower end plugs 72 and 74. The pellets 70 are maintained in a stack by a plenum spring 76 disposed between the upper end plug 72 and the top of the pellet stack. The fuel pellets 70, composed of fissile material, are responsible for creating the reactive power of the reactor. The cladding which surrounds the pellets functions as a barrier to prevention the fission by-products from entering the coolant and further contaminating the reactor system.

To control the fission process, a number of control rods 78 are reciprocally movable in the guide thimbles 84 located at predetermined positions in the fuel assembly 22. The guide thimble locations can be specifically seen in FIG. 4 represented by reference character 96, except fur the center location which is occupied by the instrumentation tubes 68. Specifically, a rod cluster control mechanism 80 positioned above the top nozzle 62, supports a plurality of control rods 78. The control mechanism has an internally threaded cylindrical hub member 82 with a plurality of radially extending flukes or arms 52 that form the spider previously noted with regard to FIG. 2. Each arm 52 is interconnected to a control rod 78 such that the control rod mechanism 80 is operable to move the control rods vertically in the guide thimbles 84 to thereby control the fission process in the fuel assembly 22, under the motive power of a control rod drive shaft 50 which is coupled to the control rod hub 80, all in a well-known manner.

As mentioned above, the fuel assemblies are subject to hydraulic forces that exceed the weight of the fuel rods and thereby exert significant forces on the fuel rods and the assemblies. In addition, there is significant turbulence in the coolant in the core caused by mixing vanes on the upper surfaces of the straps of many grids that promote the transfer of heat from the fuel rod cladding to the coolant. The significant rate of flow of coolant and the turbulence exerts substantial forces on the grid straps. In addition, the grid straps have to withstand external loads incurred during shipping and handling or from all postulated accidents such as seismic and loss of coolant accidents. Recently, the concerns over seismic events at nuclear power plants have received more attention, resulting in a tightening of the seismic requirements that fuel assemblies have to satisfy. Typically, fuel assembly grids have been strengthened by increasing the strap height, or the strap thickness, or by adding additional welds. However, each of these design improvements results in an increased pressure drop of the coolant across the fuel assembly as welt as added costs to the manufacturing process. Furthermore, adding additional metal to the grid increases the neutron capture cross section of the grid which detracts from the efficiency of the nuclear process within the core to produce heat for useful work.

Accordingly, a new fuel assembly grid design is desired that will increase the crush strength of the grid without significantly increasing the manufacturing costs or pressure drop across the grid or detract from the efficiency of the nuclear reaction within the core.

### SUMMARY

These and other objects are achieved by a nuclear fuel assembly having a parallel array of elongated fuel elements and a support grid for supporting the elongated fuel elements along their longitudinal dimension. The grid has a lattice structure which defines a plurality of cells, some of through which the fuel elements are respectively supported. Others of the cells respectively support a guide tube for a control rod with each of the cells having a plurality of wails which intersect at corners and surround the corresponding fuel element or a guide tube at the support locations. Each of the walls that supports the fuel elements has a number of dimples and/or springs and the walls that support the fuel elements are embossed with a plurality of emboss geometries that are formed in a staggered pattern with the pattern covering substantially an entire area of the wall except a contact surface of the dimples and springs that interface with the fuel rods. In one preferred embodiment, the geometry is generally circular in cross section. The geometry has a wall thickness, a wall pitch (i.e., the distance between corresponding points on the geometries), a height and a diameter, with the ratio of height to wall thickness greater than or equal to one-quarter and less than or equal to four; and a ratio of diameter to wall pitch greater than or equal to one-eighth and less than or equal to one.

In another embodiment, the geometry is generally hexagonal in cross section. The geometry has a height and width, with the ratio of the height to width greater than or equal to one-quarter and less than or equal to four; and a ratio of width to wall pitch greater than or equal to one-eighth and less than or equal to one.

In a third embodiment, the geometry is generally rectangular in cross section with rounded corners. The geometry has a height, width and length, with the ratio of the height to wall thickness greater than or equal to one-quarter and less than or equal to four; a ratio of width to length greater than or equal to one-tenth and less than or equal to one; and a ration of length to wall pitch greater or equal to one-eighth and less than or equal to one. For all embodiments, the geometries may extend on opposite sides of the wall or adjacent geometries may extend on the same side of the wall.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which this invention can be applied;

FIG. 2 is an elevation view, partially in section, of a nuclear reactor vessel and internal components to which this invention can be applied;

FIG. 3 is an elevational view, partially in section, of a fuel assembly illustrated in vertically shortened form, with parts broken away for clarity;

FIG. 4 is a plan view of an egg-crate support grid;

FIG. 5 is a front view of one wall of a fuel element support cell having one embodiment of the embossed pattern of this invention;

FIG. 6 is a perspective view of the fuel support cell wall illustrated in FIG. 5;

FIG. 7 is a bottom view of the fuel cells support wall illustrated in FIG. 6;

FIG. 8 is a schematic front view of the embossed wall pattern illustrated in FIGS. 5-7;

FIG. 9 is a laterally cross sectional view of the geometrical embossed pattern illustrated in FIG. 8;

FIG. 10 is a schematic front view of a second embodiment of the geometric embossed pattern of this invention; and

FIG. 11 is a third embodiment of the embossed geometric pattern of this invention.

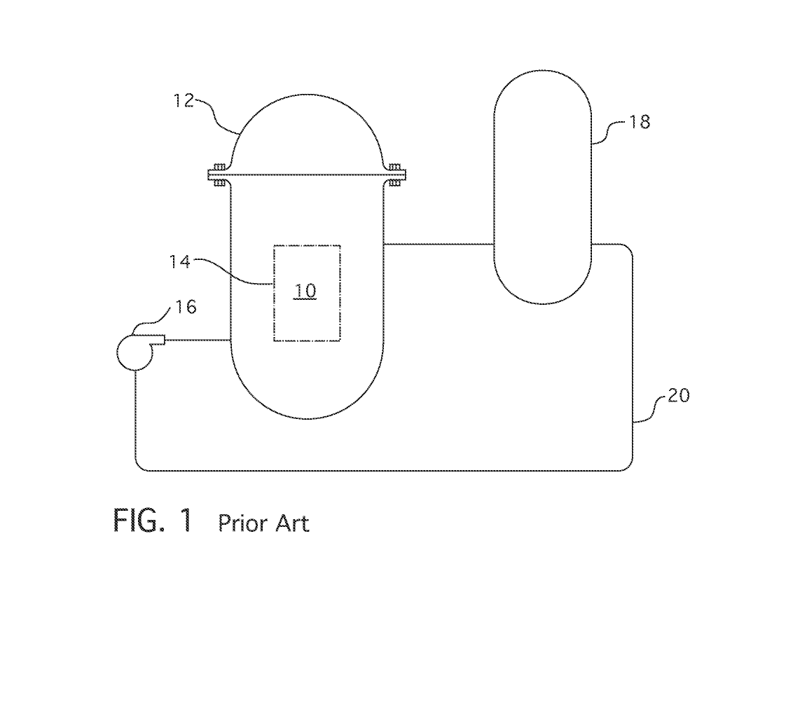

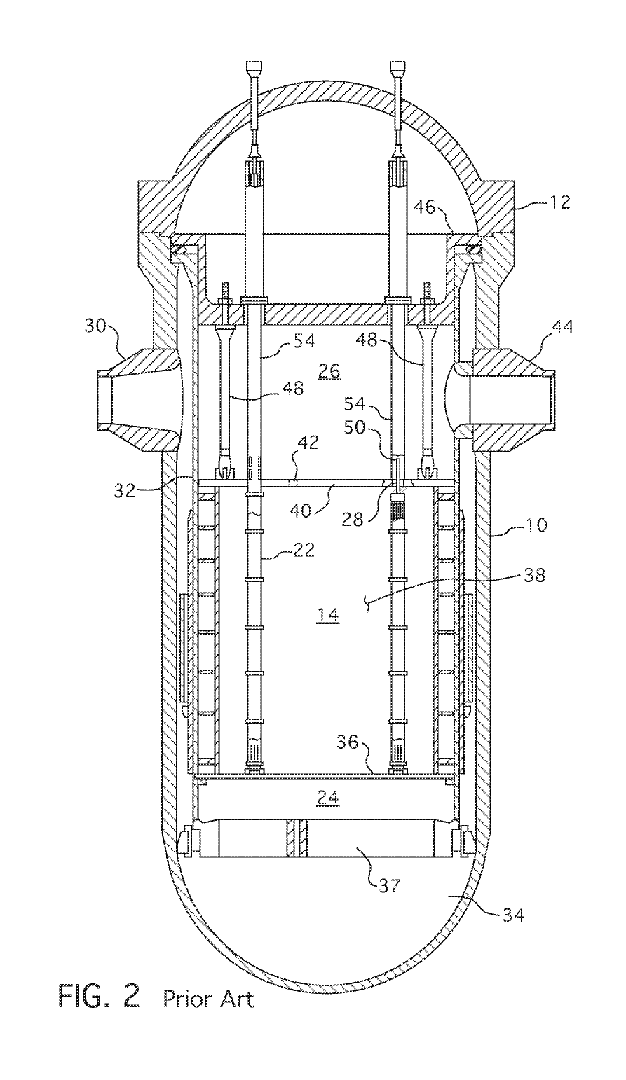

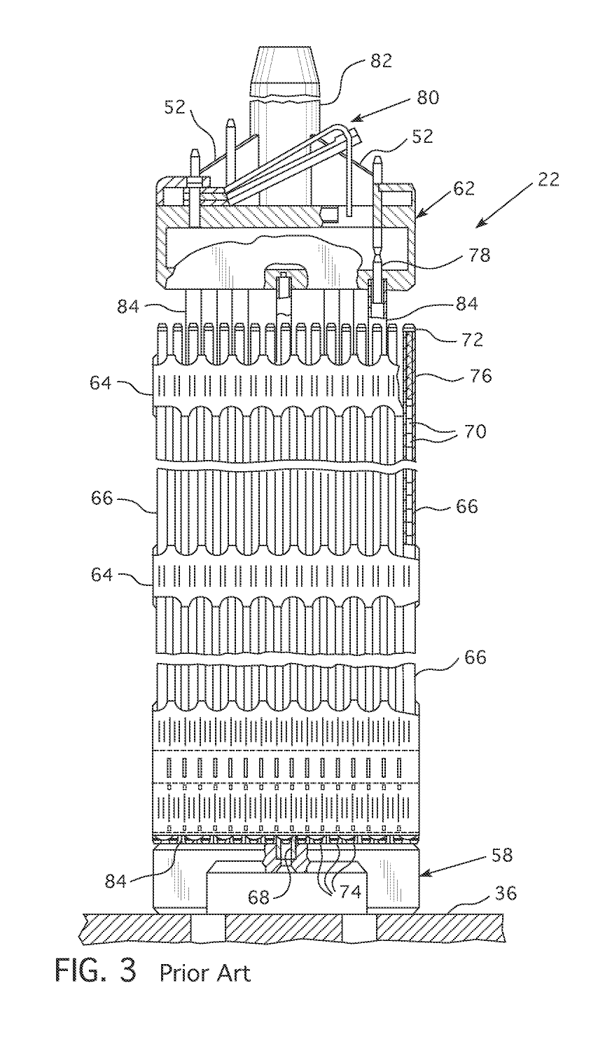

### DESCRIPTION OF THE PREFERRED EMBODIMENTS

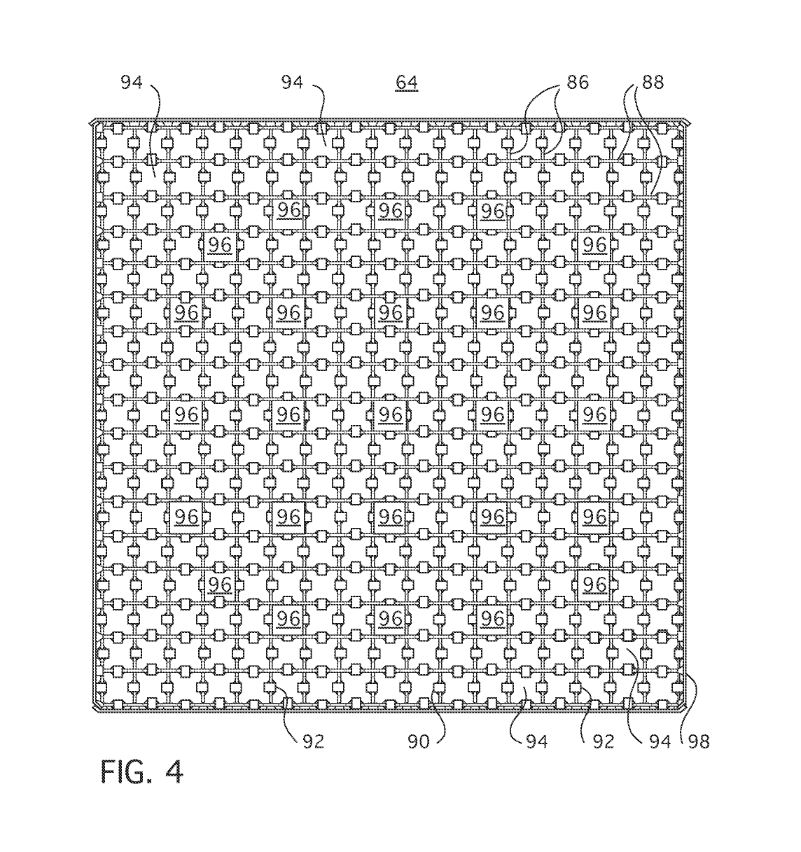

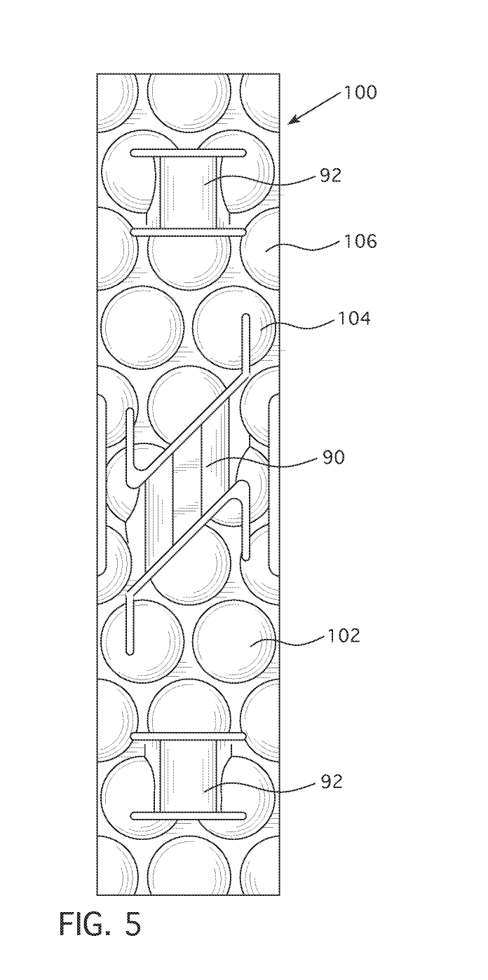

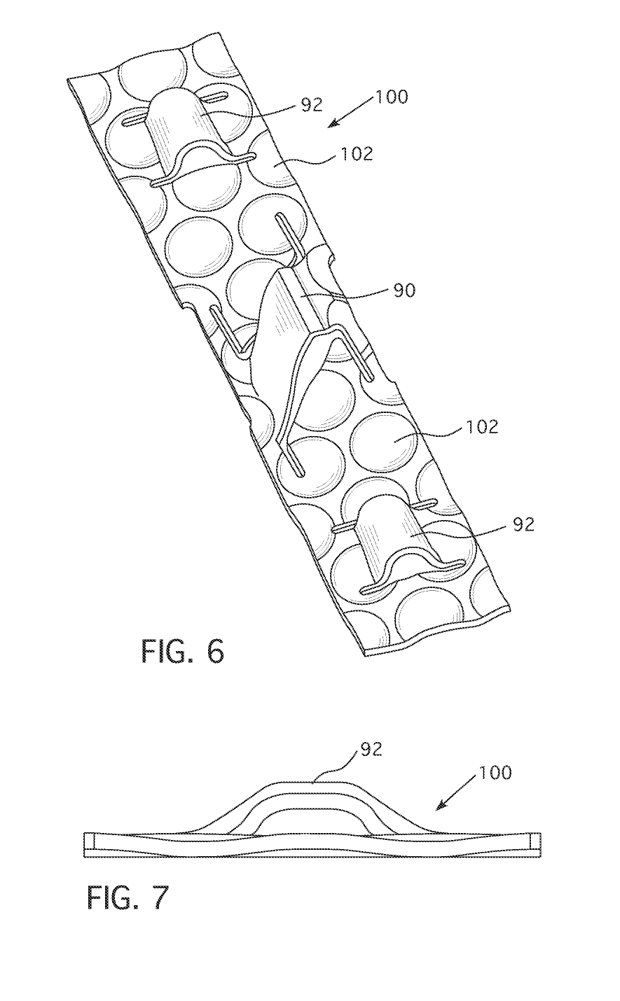

This invention provides a new fuel assembly design for a nuclear reactor and more particularly an improved spacer grid design for a nuclear fuel assembly The improved grid is generally formed from a matrix of approximately square (or hexagonal) cells, some of which 94 support fuel rods while others of which 96 are connected to guide thimbles and a central instrumentation tube. The plan view shown in FIG. 4 looks very much like the prior art grids since contour of the individual grid straps 86 and 88 that incorporate the features of the embodiments described hereafter are not readily apparent from this view, but can better be appreciated from the view shown in FIGS. 5-11. The grid of this embodiment is formed from two orthogonally positioned sets of parallel, spaced straps 86 and 88, that are interleaved in a conventional manner and surrounded by an outer strap 98 to form the structural make-up of the grid 64. Though orthogonal straps 86 and 88 forming substantially square fuel rods support cells are shown in this embodiment, it should be appreciated that this invention can be applied equally as well to other grid configurations, e.g., hexagonal grids. The orthogonal straps 86 and 88 and in the case of the outer rows, the outer straps 98, define the support cells 94 at the intersection of each four adjacent straps that surround the nuclear fuel rods 66. A length of each strap along the straps' elongated dimension between the intersections of four adjacent straps forms a wall 100 of the fuel rod support cells 94.

As previously mentioned, among the various functions, a spacer grid provides lateral support for a fuel assembly to assure the insertion of control rods is not impeded under any normal or accident conditions. However, postulated accident loads are always locally intense on the structural grids. These loads can, under certain circumstances, exceed the grid crush strength, which requires reevaluation of the loading conditions, or coolant geometry and control rod insertion analysis, or even a redesign of the spacer grid. This invention adds a three-dimensional embossed geometry to the walls of the cells that support fuel rods. One embodiment of the embossed geometry shown on a single wall of a support cell 100 is illustrated in FIGS. 5-7. Though one wall of a fuel element support cell with an embossed geometry is illustrated it should be appreciated that the embossed geometry may extend over two or more of the wails of each fuel element support cell. The embossed geometry in this embodiment is formed from rows 104 with alternate rows 106 offset in a staggered manner so that the alternate rows 106 are nested between the geometric shapes 102 of the adjacent rows 104. Preferably, the geometric shapes 102 are not stamped into the contact surfaces of the dimples 92 or the springs 90 to avoid fretting of the fuel rods.

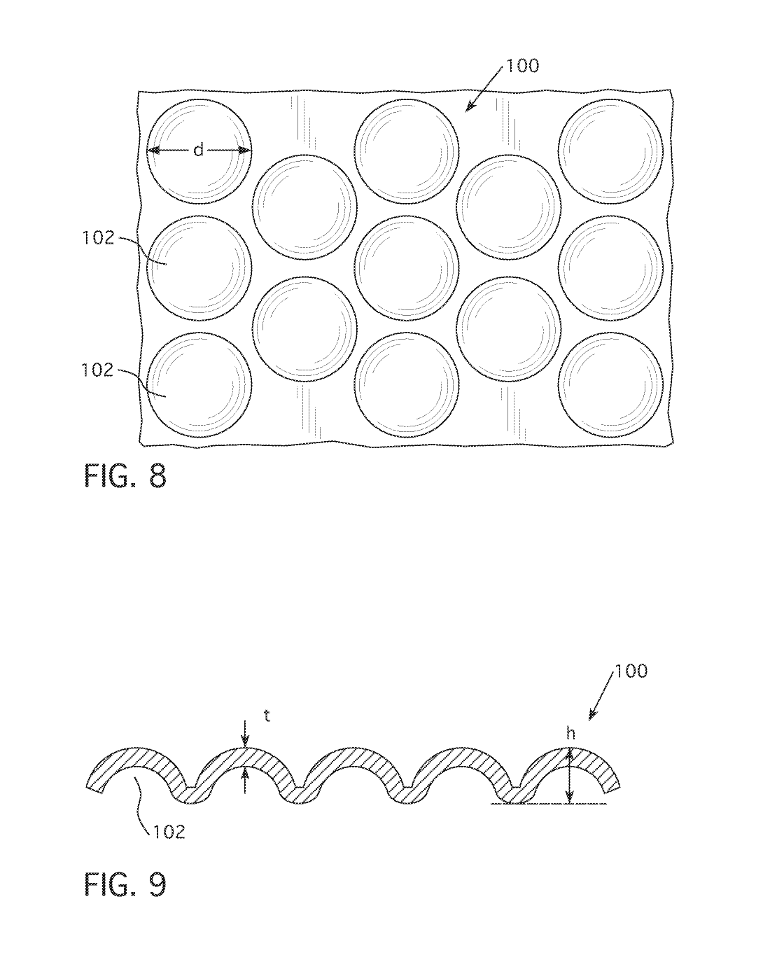

FIGS. 8 and 9 are schematic views of the cell wall illustrated in FIGS. 5-7 and show the height h and diameter d of the geometric pattern that can be stamped in one or in alternated directions into the grid strap wall. Computational results have shown that the optimal ranges for the height hand diameter d of the geometrical shape 102 are between the ratio of height to wall thickness greater than or equal to one-quarter and less than or equal to four, and the ratio of the diameter to wall pitch greater than or equal to one-eighth and less than or equal to one.

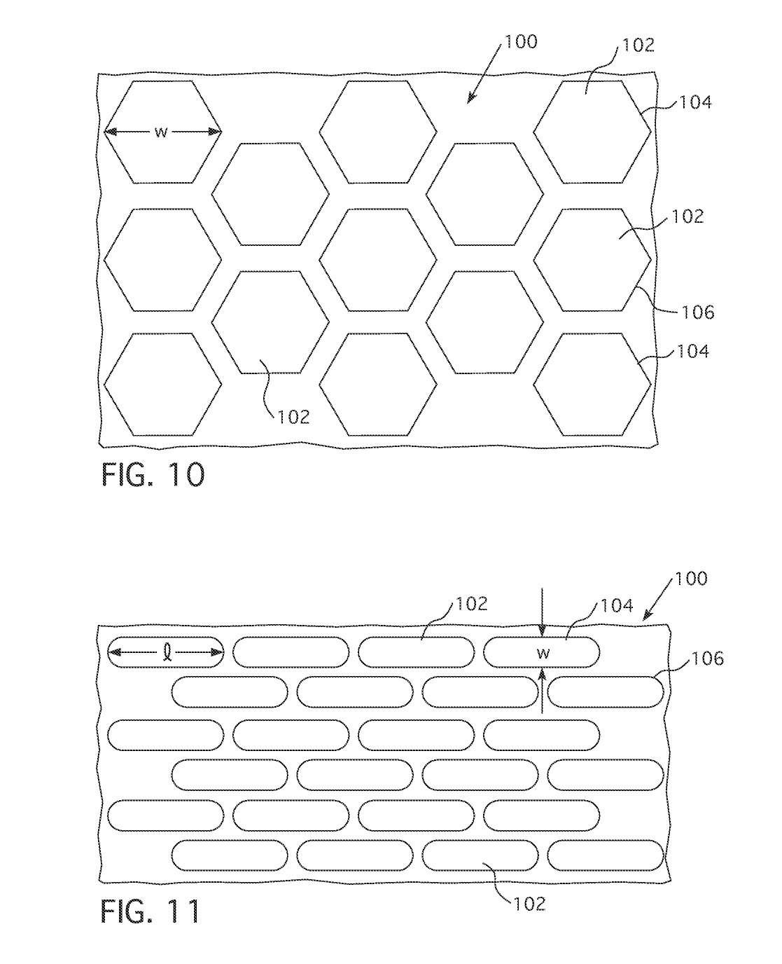

FIG. 10 shows a second embodiment that employs hexagonal geometric shapes and FIG. 11 shows a third embodiment that includes generally rectangular geometric shapes with rounded corners. Like reference characters are used among the several embodiments to identify corresponding features. For the rounded rectangular staggered patterns such as one illustrated in FIG. 11, the optimal ranges for the width w and the length l are between the ratio of width to length greater than or equal to one-tenth and less than or equal to one; and the ratio of length to wall pitch greater than or equal to one-eighth and less than or equal to one. It is expected that the hexagonal and rounded rectangular staggered patterns provide higher mechanical properties compared to the circular geometry.

As previously mentioned, the three-dimensional embossed geometries are formed only on the flat surfaces of the straps, in one or in alternating directions. The fuel rod supports (i.e., the springs and dimples) preferably formed with smooth surfaces to minimize fretting wear.

Thus, this invention provides improved grid strength with minimal increase in manufacturing costs and optionally enables the thickness of the straps to be slightly reduced which will contribute to a reduction in pressure drop across the grid.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear fuel assembly comprising:
a parallel array of elongated fuel elements;
a support grid for supporting the elongated fuel elements along their longitudinal dimension, the grid having a lattice structure which defines a plurality of cells, some of through which the fuel elements are respectively supported, others of which respectively support a guide tube for a control rod, each of the cells having a plurality of walls which intersect at corners and surround the corresponding fuel element or a guide tube at the support locations; and
wherein each of the walls that supports the fuel elements has a number of dimples and/or springs and the walls that support the fuel elements are embossed with a plurality of emboss geometries that are formed in a symmetrical pattern with the pattern covering substantially an entire area of the wall except a contact surface of the dimples and springs that interface with the fuel elements.

2. The nuclear fuel assembly of claim 1 wherein the emboss geometry is generally circular in cross-section.

3. The nuclear fuel assembly of claim 1 wherein the emboss geometry is generally hexagonal in cross-section.

4. The nuclear fuel assembly of claim 1 wherein the emboss geometry is generally rectangular in cross-section.

5. The nuclear fuel assembly of claim 4 wherein the cross-section has rounded corner.

6. The nuclear fuel assembly of claim 3 wherein the geometry has a width and a length, with the ratio of width to length greater than or equal to 1/10 and less than or equal to 1.

7. The nuclear fuel assembly of claim 1 wherein the emboss geometries are arranged in alternate, staggered rows.

8. The nuclear fuel assembly of claim 1 wherein the emboss geometry has a height and a wall thickness, with the ratio of the height to wall thickness greater than or equal to ¼ and less than or equal to 4.

9. The nuclear fuel assembly of claim 1 wherein the plurality of emboss geometries has a diameter and a wall pitch, with the ratio of the diameter to the wall pitch greater or equal to ⅛ and less than or equal to 1.

10. The nuclear fuel assembly of claim 1 wherein the plurality of emboss geometries have a width and the watts that support fuel elements have a pitch and the ratio of the width to the pitch is greater than or equal to ⅛ and less than or equal to 1.

11. The nuclear fuel assembly of claim 1 wherein adjacent emboss geometries extend on opposite sides of the wall.

12. The nuclear fuel assembly of claim 1 wherein adjacent geometries extend on the same side of the wall.

13. A nuclear fuel assembly nuclear fuel element support grid comprising:
a lattice structure which defines a plurality of cells, at least some of which are configured to respectively support a nuclear fuel element, each of the cells that support the fuel element having a plurality of walls which intersect at corners and surround the corresponding fuel element; and
wherein the walls that support the fuel element has a number of dimples and/or springs and are embossed with a plurality of emboss geometries that are formed in a symmetrical pattern with the pattern covering substantially an entire area of the wall except a contact surface of the dimples and springs that interface with the fuel element.

14. The nuclear fuel element support grid of claim 13 wherein the emboss geometries are arranged in alternate, staggered rows.

15. The nuclear fuel element support grid of claim 13 wherein the emboss geometry has a height and a wall thickness, with the ratio of the height to wall thickness greater than or equal to ¼ and less than or equal to 4.

16. The nuclear fuel element support grid of claim 13 wherein the plurality of emboss geometries has a width and a wall pitch, with the ratio of the width to the wall pitch greater than or equal to ⅛ and less than or equal to 1.

17. The nuclear fuel element support grid of claim 13 wherein the plurality of emboss geometries have a pitch and the walls that support fuel elements have a width and the ratio of the pitch to the width is greater than or equal to ⅛ and less than or equal to 1.
